(19) United States
(12) Patent Application Publication
(10) Pub. No.: US 2006/0155810 A1
(43) Pub. Date: Jul. 13, 2006

(54) Method and device for electronic mail

(76) Inventor: Paul Butcher, Cambridgeshire (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/534,674

(22) PCT Filed: Nov. 13, 2003
(86) PCT No.: PCT/GB03/04927

§ 371 Date: Sep. 28, 2005

(30) Foreign Application Priority Data
Nov. 14, 2002 (GB) 0226596.5

(51) Int. Cl. G06F 15/16

(52) U.S. Cl. 709/206

(57) ABSTRACT

A method manages emails in a mobile terminal of a mobile email system. The mobile email system including an email system and an email server coupled to a static terminal and in wireless communication with said mobile terminal. The static terminal has a folder-based data storage structure for storing emails received by a user of said static terminal. The email server is also configured to provide said received emails to said mobile terminal. The mobile terminal locally duplicates at least a portion of said state terminal folder-based data storage structure. The user is able to manage emails sent to a single address using said static and said mobile terminal. The method includes inputting, at said mobile terminal, a command from said user to move an email from a first of said local storage folder structure to a second folder of said local storage structure. The method further includes deleting said email from said local storage of said mobile terminal responsive to said user move command. The method further includes sending said move command from said mobile terminal to said email server.

This invention is generally concerned with data communications systems, more particularly systems and methods for managing mobile email.

Computer network communications employ standard protocols, the most common of which is the TCP/IP family of protocols. These protocols include file transfer (FTP), remote log in and computer mail protocols. Data communications generally operate on a client-server model, a server being a computer program or system that provides a specific service for one or more clients. In TCP/IP TCP (Transmission Control Protocol) breaks a message down into datagrams and reassembles them on receipt whilst IP (Internet Protocol) is a connectionless packet switching protocol responsible for routing the individual datagrams. Most IP traffic uses the TCP protocol although other protocols such as RDP (Reliable Data Protocol) and UDP (User Datagram Protocol) are also available. Most data communications between software processes uses TCP which provides a simple, connection-oriented protocol which hides error handling and guarantees a reliable link.

To communicate using the TCP protocol a connection must be established between a pair of sockets, one on the server process the other on the client process. The server process listens for a connection request following which a three-way handshake establishes a connection Once a TCP connection is established it behaves, broadly speaking, like a piece of wire in which bidirectional, error-fee communication is available and in which data arrives in the same order in which it was sent. It can therefore be readily understood why the use of TCP to communicate between software processes is almost ubiquitous.

The sockets between which the TCP connection is established may be specific to the client-server processes, but a number of “well-known” sockets have also been defined for processes such as FTP (socket 21) web browsing (socket 80) and e-mail (socket 25) and many systems have server processes listening for connections to the sockets. It should be understood, however, the use of TCP/IP is not restricted to the Internet and these protocols are also used, for example, in a typical corporate network, for example, over Ethernet.

As mentioned above, socket 25 is for e-mail communication, more specifically communication using SMTP (Simple Mail Transfer Protocol). E-mail is delivered by a source machine establishing a connection to port 25 of the destination machine, which operates as the server. The SMTP is defined by RFC (Request for Comments) 821, the e-mail format is defined by RFC 822, and an extended SMTP protocol is defined in RFC 1425. Once an e-mail has been received by the server it is stored in the recipient's mailbox, typically a file on the server machine, from where it can be read using a mail browser/manager on a desktop terminal coupled to the server over a local network. The server process is sometimes called a Message Transfer Agent (MTA) and the e-mail browser/manager is sometimes called a Mail User Agent (MUA). A desktop terminal user wishing to send an e-mail composes the e-mail using the mail browser/manager, which passes it to the server to forward for delivery (alternatively the message may be composed on the server). Many e-mail systems support MIME Multipurpose Internet Mail Extensions) attachments in which binary data is encoded as text (base 64) as defined in RFCs 2045-2049. This allows message body of an e-mail to contain an “attachment” such as an image data file.

SMTP is a server machine to server machine protocol. A well-known message transfer agent using SMTP is sendmail, which runs under Unix. In a PC-based system Microsoft Exchange (Trade Mark) may be used. A commonly used mail user agent providing e-mail viewing and management is Microsoft Outlook (Trade Mark). Microsoft's Messaging API (MAPI) may be run on a desktop PC to provide e-mail communication services to applications running on the PC (Personal Computer). MAPI communicates with Microsoft's Exchange server and allows software processes to register for notification of e-mail arrival and allows software processes to send e-mails, among many other functions.

Although SMTP is the most common and popular e-mail protocol, other e-mail protocols are also employed, such as the Notes protocol for use with IBM Lotus Notes (Trade Mark). There are also proprietary e-mail protocols, such as the protocol which may be employed when, for example two Microsoft Exchange servers are talking to one another. A corporate e-mail server machine may also run POP (Post Office Protocol) server to store incoming e-mail until the receiving client is ready to accept it. Many systems employ the POP3 protocol or its replacement IMAP (Internet Message Access Protocol).

Data transmission is also becoming increasing important within mobile phone networks, and in particular within so-called 2.5G and 3G (Third Generation) networks. These 2.5G and 3G networks, are encompassed by the International Mobile Telecommunications IMT-2000 standard (www.ituint), hereby incorporated by reference. Third generation technology uses CDMA (Code Division Multiple Access) for communicating across the radio interface between a mobile station and a base station and the IMT-2000 standard contemplates three main modes of operation, W-CDMA (Wide band CDMA) direct spread FDD (Frequency Division Duplex) in Europe and Japan, CDMA-2000 multicarrier FDD for the USA, and TD-CDMA (Time Division Duplex CDMA) and TD-SCDMA (Time Division Synchronous CDMA) for China

Collectively the radio access portion of a 3G network is referred to as UTRAN (Universal Terrestrial Radio Access Network) and a network comprising UTRAN access networks is known as a UMTS (Universal Mobile Telecommunications System) network. The UMTS system is the subject of standards produced by the Third Generation Partnership Project (3GPP, 3GPP2), technical specifications for which can be found at www.3gpp.org These standards include Technical Specifications 23.101, which describes a general UMTS architecture, and 25.101 which describes user and radio transmission and reception (FDD) versions 4.0.0 and 3.2.2 respectively, which are also hereby incorporated by reference.

Mobile cellular communications systems such as GPRS (General Packet Radio Service) and 3G systems add packet data services to the circuit switched voice services of a 2G GSM (Group System for Mobile communications)-based system. User end equipment for data communications typically comprises a mobile station or handset, which may be referred to as a mobile terminal (MT), incorporating a SIM (Subscriber Identity Module) card. The handset may be coupled to a personal computer, sometimes referred to as Terminal Equipment (TE), by means of a wired or wireless serial connection, for example a Bluetooth link Sometimes the handset may require a terminal adapter, such as a GSM datacard. Typically the terminal equipment communicates with the handset using standard AT commands as defined, for example, in 3GPP Technical Specification 27.007, hereby incorporated by reference.

Once a handset has attached to a GPRS network it is effectively “always on” (when switched on) and user data can be transferred transparently between the handset and an external data network. The wireless network is provided with a wireless gateway to allow a mobile device (MT or TE) to be accessed, for example via the Internet, using standard TCP/IP protocols.

It is desirable to be able to send and receive e-mails from a mobile device and many Palm Top computers and PDAs (Personal Digital Assistants) have e-mail clients and browsers. These allow an e-mail account to be set up with an e-mail address, for example self@mymobiledevice.com but this introduces problems of synchronisation between e-mails on the mobile device and e-mails on, for example, a desktop PC on a corporate network which is also used for e-mail communication. Furthermore because these two systems have different e-mail addresses e-mails may be sent to the “wrong address”. WO 99/63709 describes a solution to this problem in which a redirector programme operating on a desktop computer redirects user-selected data items from a host system to the user's mobile device upon detecting that one or more user-defined triggering events have occurred. However further problems arise in corporate environments.

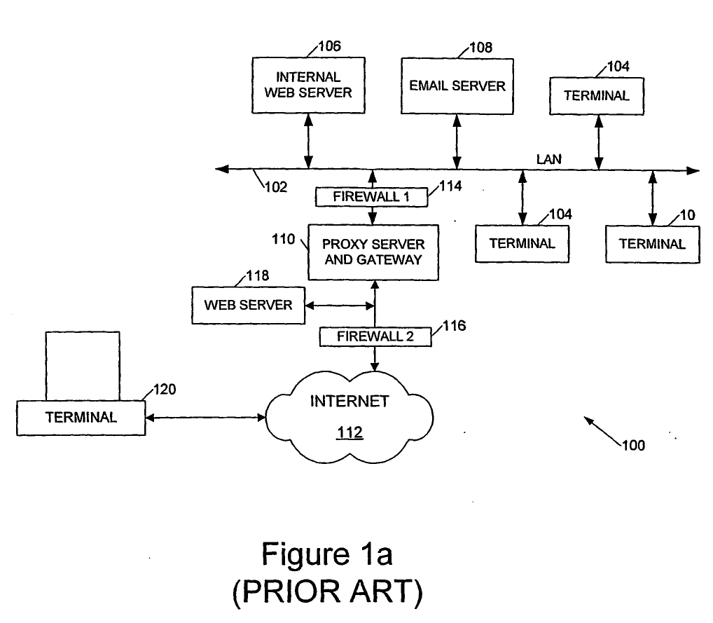

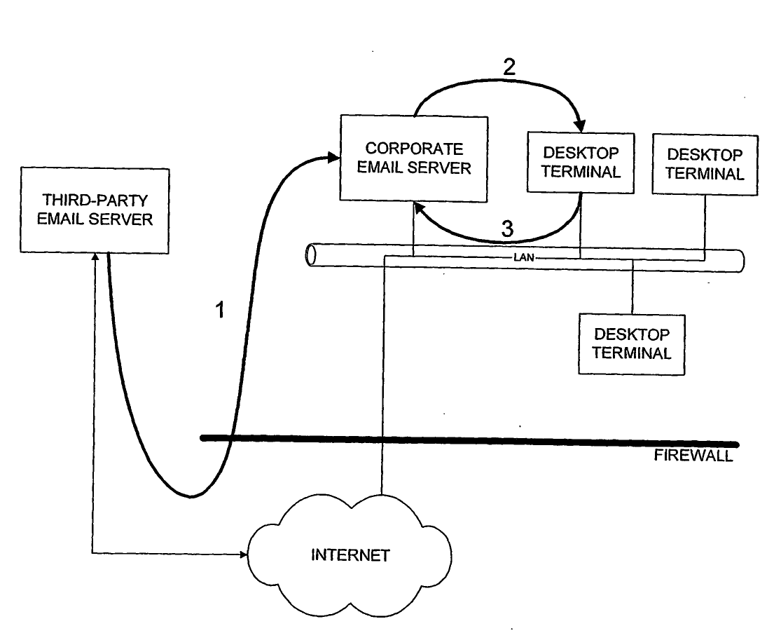

A typical (simplified) corporate network 100 is shown in FIG. 1a. A corporate LAN (Local Area Network) 102 connects a plurality of user terminals 104, typically desktop PCs, with an internal web server 106, and e-mail server 108 as described above, and a proxy server and gateway 110. Proxy server and gateway 110 provides a single connection to the outside world, and in particular to the Internet 112, to control external access to LAN 102 and to the devices attached to this network. As will be known to those skilled in the art proxy server 110 typically translates “internal” IP addresses to one or more valid “external” IP addresses and provides data caching, filtering and control functions. Proxy server 110 may be referred to as a firewall machine since one of its purposes is to masquerade to the Internet 112 as an internal client, such as one of terminals 104, substituting its IP address for a client terminal's IP address to thereby hide the client terminal from the Internet 112. Typically the corporate network will also include one or more firewalls, such as firewalls 114 and 116 to provide additional security. These may run on the proxy server machine or on separate machines. The firewalls typically perform IP packet filtering based upon packet type, source address, destination address and/or port (i.e. socket) data in each packet. Filtering may also be based upon payload data, for example to implement keyword-based access restrictions. In the example shown Firewall 116 allows controlled access to an external web server 118 and firewall 114 provides additional protection for corporate LAN 102. In this way a terminal connected to Internet 112, such as terminal 120, may be provided with limited access to external web server 118 and, for example, e-mail access to e-mail server 108 but may be denied, for example, any FTP access either to web server 118 or to any of the other elements of the corporate network.

FIG. 1b shows a typical corporate email system. A series of desktop terminals (PCs) are connected to a LAN. A corporate e-mail server resides on the same LAN. The LAN is connected to the Internet via a firewall. A third-party e-mail server is also connected to the Internet. The steps indicated by numbered arrows 1, 2 and 3 are:
1. The third-party e-mail server sends a message to the corporate e-mail server via the Internet and through the firewall.
2. The corporate e-mail server notifies the relevant user's PC that a new message has arrived. The message is retrieved by the user and displayed on the user's terminal.
3. After reading the message, the user files it in a folder.

Email systems typically support the concept of “folders” which can be used to file messages. Such folders are of particular use when the volume of e-mail received is high, allowing users to design their own filing system and keep related messages in a structure that facilitates subsequent usage.

E-mail has traditionally been accessed via a desktop computer, but recently portable wireless devices with the ability to access e-mail are becoming more widespread. In particular, systems (e.g. Commtag Duality Trade Mark) are becoming available that allow a user's portable device to be used to access the same account as their desktop. Operations on the user's device are mirrored on their desktop and vice-versa

Mobile wireless devices operate under a number of very tight constraints. They need to be small and light enough to be easily portable and yet be large enough to allow a readable display and a convenient means of text entry. They need to offer adequate battery life to allow the device to be used for extended periods without recharging and they need to be available at an affordable price. These constraints mean that the facilities provided by such devices are often very limited when compared to the facilities available on a desktop computer. In particular the amount of storage (both main memory and backing storage) provided by such devices is typically an order of magnitude less than on a desktop computer.

In the context of e-mail, these limits introduce a tension that any system needs to resolve. On the one hand, the user would like to be able to use their portable device as a “mini-desktop”, to have access to all of the information, and to be able to perform any operation that's available on their desktop. On the other hand, the device may not have enough space available to hold all of this information (and even if it does, the user may want to make that space available for other applications).

When a desktop terminal user downloads an email a local copy of the email is stored on the terminal and can be moved to another local file or folder. Alternatively the email may be copied to storage on the corporate email server. A problem arises when implementing email on a mobile terminal since the natural way of doing this would be to give the mobile terminal its own email address. This introduces problems synchronisation and difficulties associated with knowing which email address to use. A solution to this problem is to download or mirror emails received at the desktop terminal's address to the mobile terminal. Preferably actions on the mobile terminal are then replicated on the desktop terminal as if the actions were performed on the desktop terminal, thus maintaining synchronisation. How this can be achieved is described later in this specification, and reference may also be made to the applicant's earlier UK patent application number 0211736.4 filed on 21^{st} May 2002. However another problem arises in this context that of storage space on the mobile terminal. In the case of a desktop terminal connected to a corporate email server by a LAN, an email may be moved to storage on the server, but with a mobile terminal there are many occasions when this is not possible. Even when such a conventional file move operation is possible the complete data for the email must be transferred over the network, which imposes a relatively large data communication overhead undesirable for mobile operation where bandwidth is often limited.

According to a first aspect of the invention there is therefore provided a method of managing emails in a mobile terminal of a mobile e-mail system, the mobile email system comprising an email server coupled to a static terminal and in wireless communication with said mobile terminal, said static terminal having a folder-based data storage structure for storing emails received by a user of said static terminal, said email server also being configured to provide said received emails to said mobile terminal, said mobile terminal locally duplicating at least a portion of said static terminal folder-based data storage structure, whereby said user is able to manage emails sent to a single address using said static and said mobile terminal, the method comprising: inputting, at said mobile terminal, a command from said user to move an email from a first folder of said local storage structure to a second folder of said local storage structure; deleting said email from said local storage of said mobile terminal responsive to said user move command; and sending said move command from said mobile terminal to said email server.

Broadly speaking, in embodiments the mobile terminal mirrors the file or folder structure of the static desktop terminal but without mirroring the email data actually stored in the folders, or at least in some of the folders. (Here the expression “folder” is used generally to refer to any organised email container such as a file or directory). This has the advantage that an email move operation, for example from an inbox to another folder may be implemented by a local delete operation, so freeing up the storage which was occupied by the email. Furthermore the move may be implemented at the server end or on the static terminal merely by the mobile terminal sending back an appropriate move command, without the need to send back the data representing the moved email over the mobile terminal link. Normally the static terminal will have its own local folder-based storage, although it may rely upon storage within an email server. In a preferred embodiment the mobile terminal sends the move command back to the server by means of a “command” or “protocol” mail, that is encoding the command as a very short email. Again in a preferred embodiment the mobile terminal communicates with a mobile terminal email server, optionally via a relay server, which in turn communicates with a conventional corporate email server. Communication between the mobile terminal and the corporate server, via the mobile terminal e-mail server, is preferably over the internet, the mobile terminal connecting to the mobile terminal server at intervals to check for new emails and the like.

The mobile terminal may comprise any mobile computing device including, but not limited to, a mobile phone, a wireless-enabled PDA, and a computer coupled to a mobile phone or other mobile communications device. The mobile terminal is coupled to a digital mobile communications network, which may be a digital mobile phone network as described above or some other mobile communications network, for example a Hiperlan/2 network. Preferably the mobile terminal processes the data it receives to convert it to a standard e-mail data format, such as that defined in RFC 822, or any other standard format so that it may then be made available to any conventional e-mail application, for example for reading and manipulation by a user.

In a related aspect the invention provides a mobile terminal for a mobile email system, the mobile email system comprising an email server coupled to a static terminal and in wireless communication with said mobile terminal, said static terminal having a folder-based data storage structure for storing emails received by a user of said static terminal, said email server also being configured to provide said received emails to said mobile terminal, said mobile terminal comprising: program memory storing processor implementable instructions; data memory locally duplicating at least a portion of said static terminal folder-based data storage structure; and a processor coupled to said program memory and to said data memory, for loading and implementing said instructions, said instructions comprising instructions for controlling the processor to: input, at said mobile terminal, a command from said user to move an email from a first folder of said local storage structure to a second folder of said local storage structure; delete said email from said local storage of said mobile terminal responsive to said user move command; and send said move command from said mobile terminal to said email server.

The invention also provides processor control code for the terminal and code to, when running, implement the above described method.

Related systems, methods and terminals may be used for managing documents stored in folders instead of emails.

The invention further provides terminals and systems configured to operate in accordance with the above methods, and terminals and systems incorporating the above-described processor control code.

The processor control code may be provided on a data carrier or storage medium such as a hard or floppy disk, ROM or CD-ROM, or on an optical or electrical signal carrier, for example via a communications network. The processor control code may comprise program code in any conventional programming language such as Java, C and the like. The methods implemented by the code may be implemented as either client or server processes on either a single machine or distributed over a plurality of machines. Aspects of the invention are particularly suited to implementation over a communications network such as the Internet, an intranet or an extranet, and the communications link may include a wireless link such as a Bluetooth (Trade Mark) link or wireless LAN link. Embodiments of the invention may be implemented on general purpose computer systems using appropriate software.

These and other aspects of the invention will now be further described by way of example only with reference to the accompanying figures in which:

FIGS. 1a and 1b show respectively, a typical corporate computer network with a connection to the Internet, and a typical corporate email process;

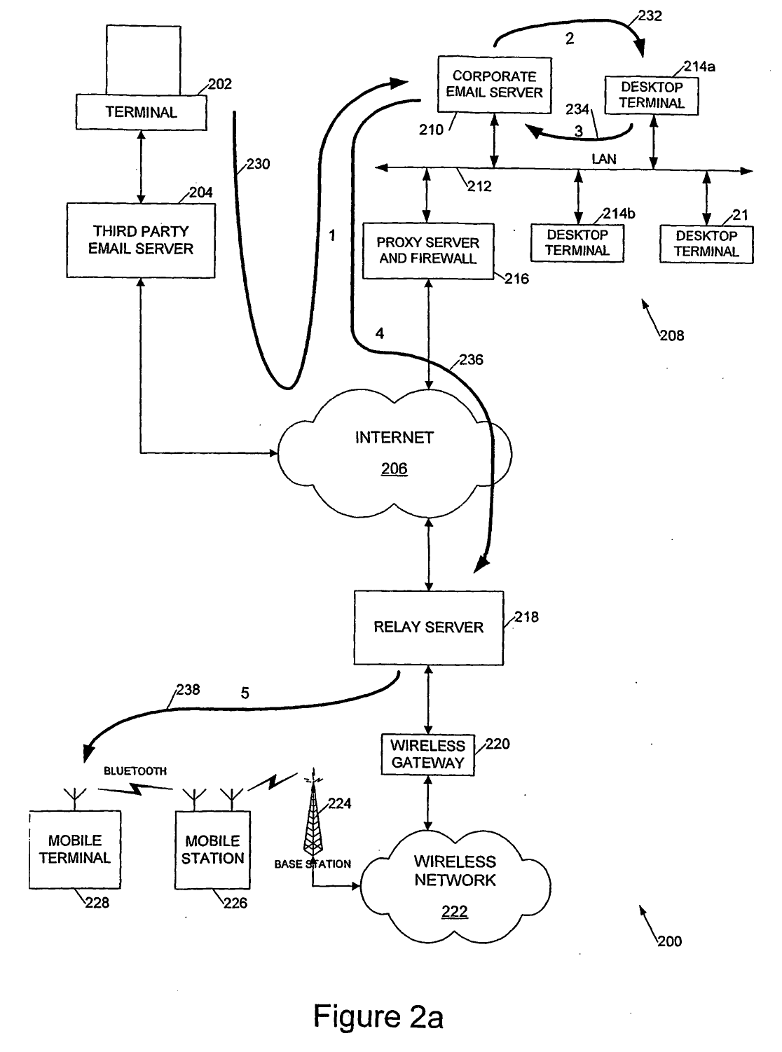

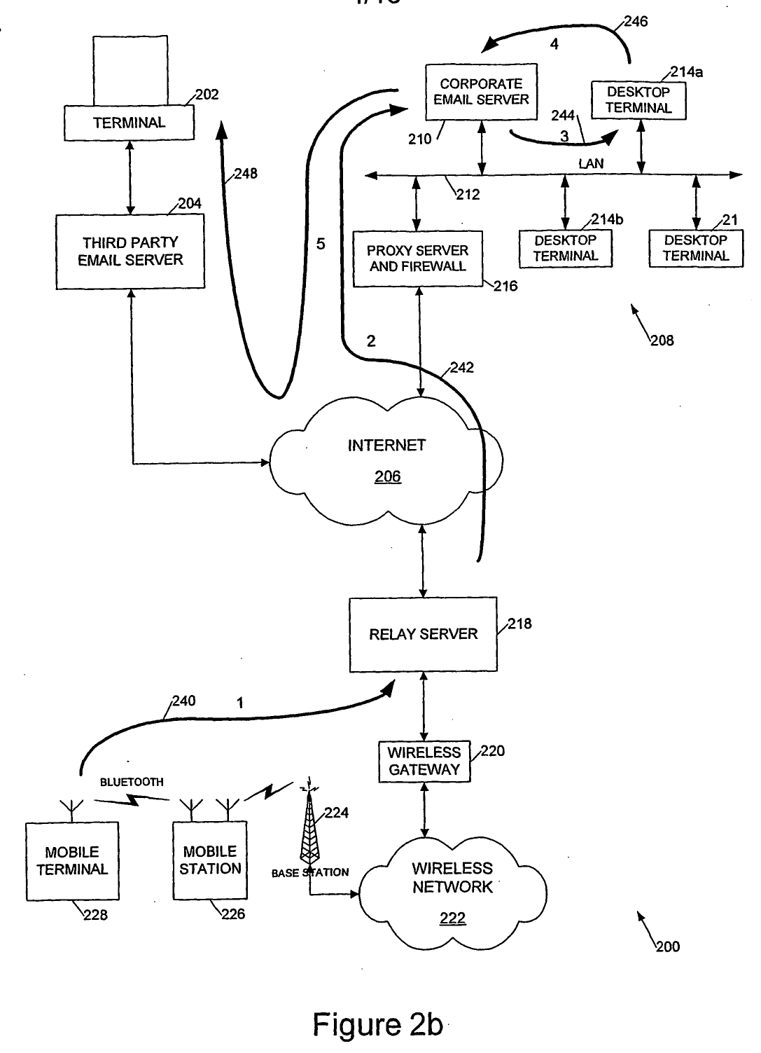

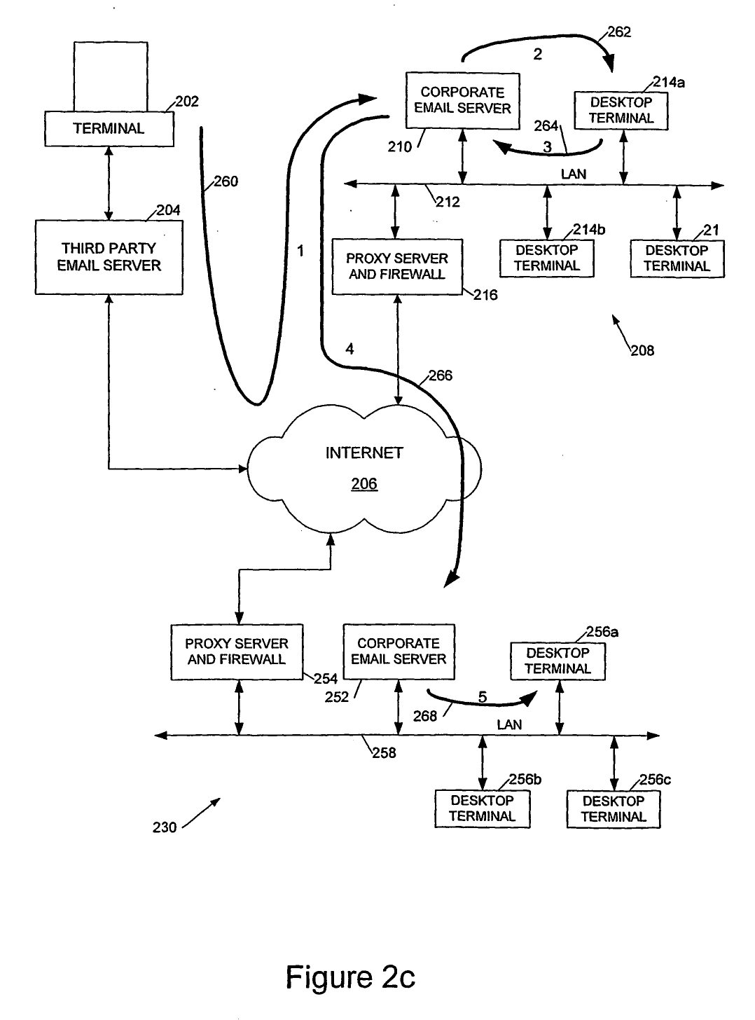

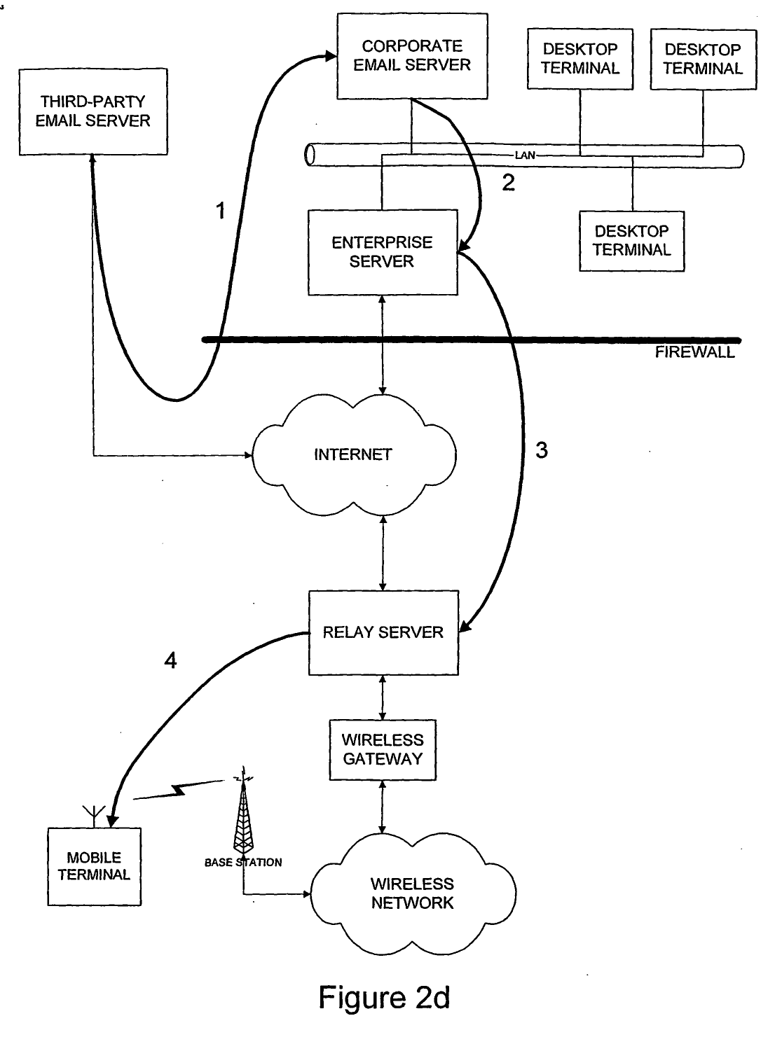

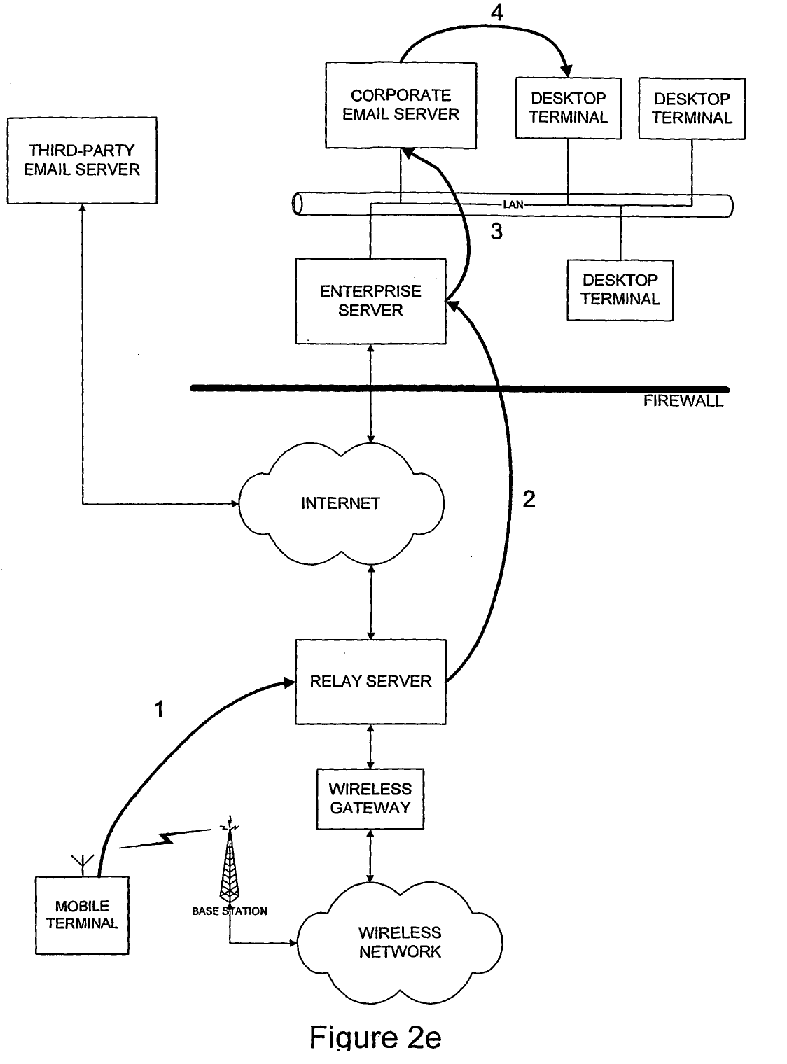

FIGS. 2a to 2e show information flows in mobile email systems when, respectively, e-mail is sent from a third party to a mobile device via a corporate network, e-mail is sent from a mobile device to a third party via a corporate network, e-mail is sent between user terminals of two corporate networks, e-mail is sent from a third party to a mobile device via a corporate network, and email is filed on a mobile terminal;

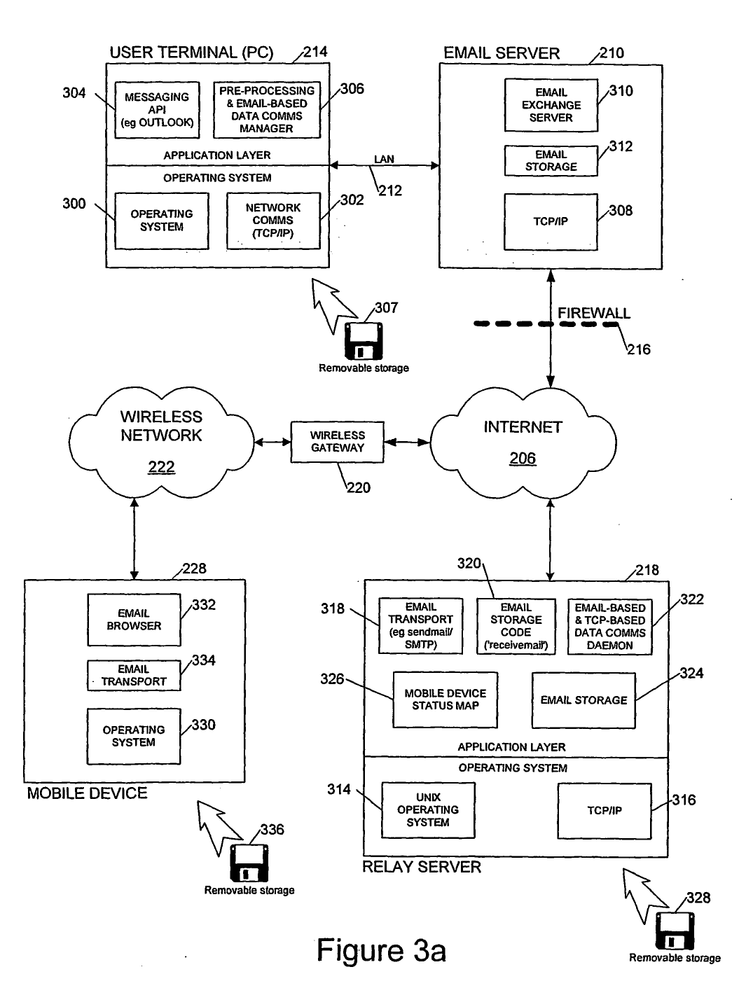

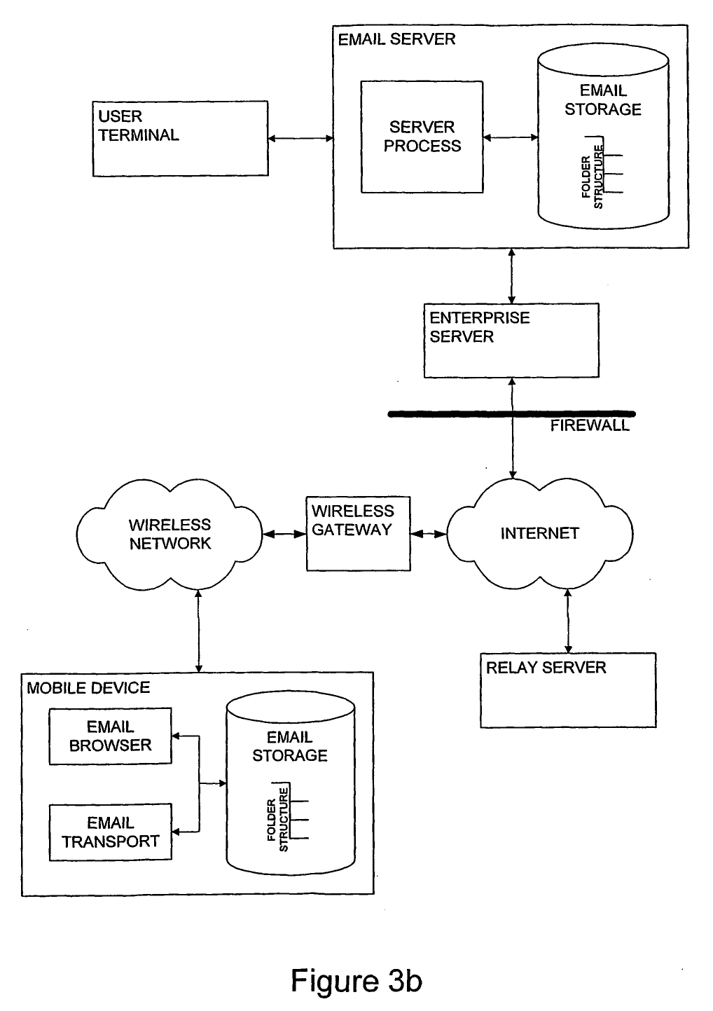

FIGS. 3a and b show block diagrams of mobile email systems;

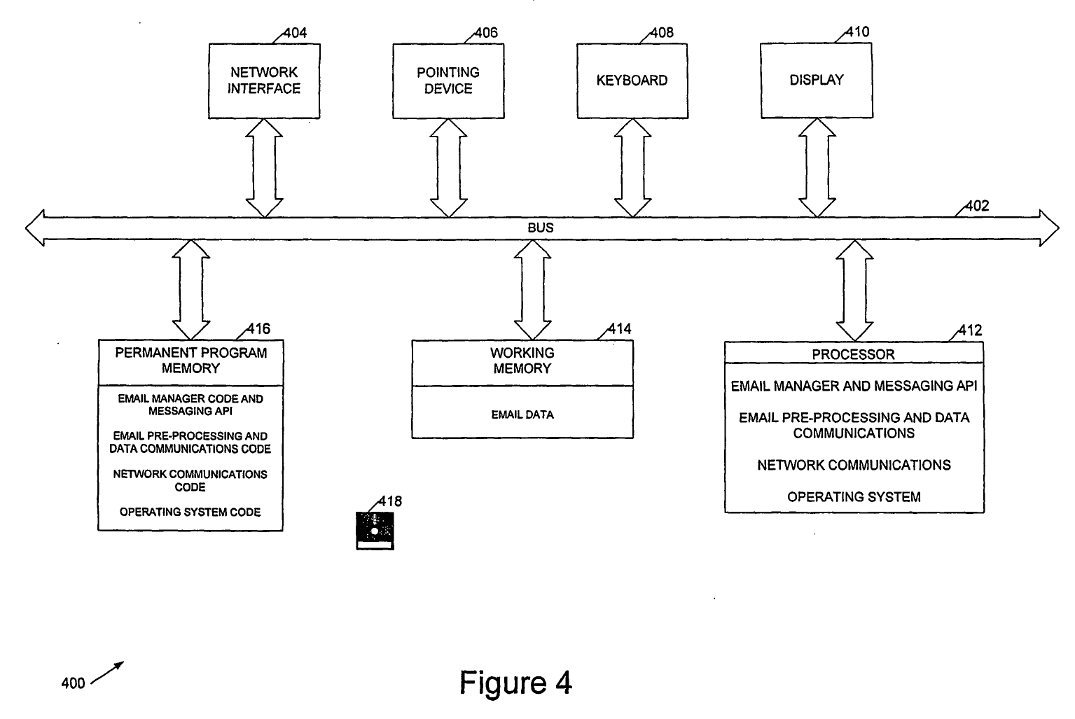

FIG. 4 shows a general purpose computer suitable for use in the systems of FIGS. 2a, b and c;

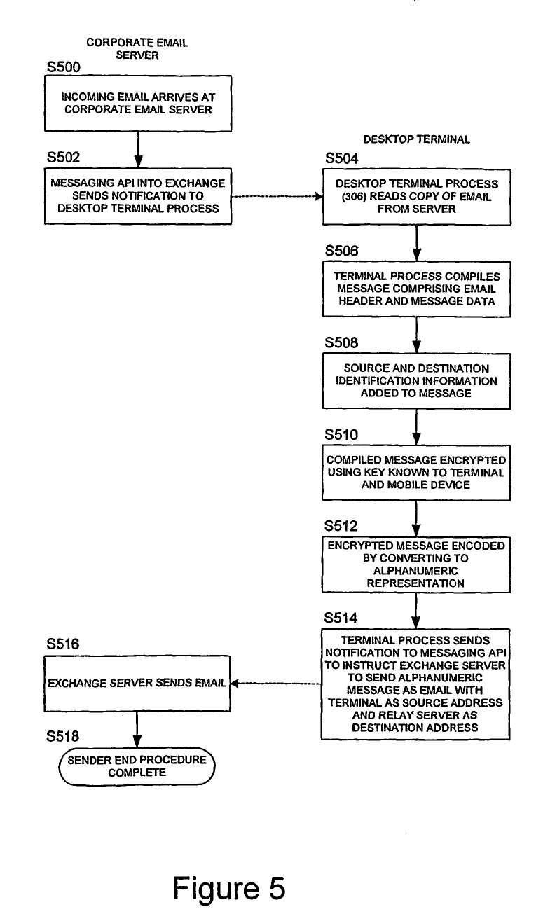

FIG. 5 shows a flow diagram of a user terminal process for establishing a data communications link;

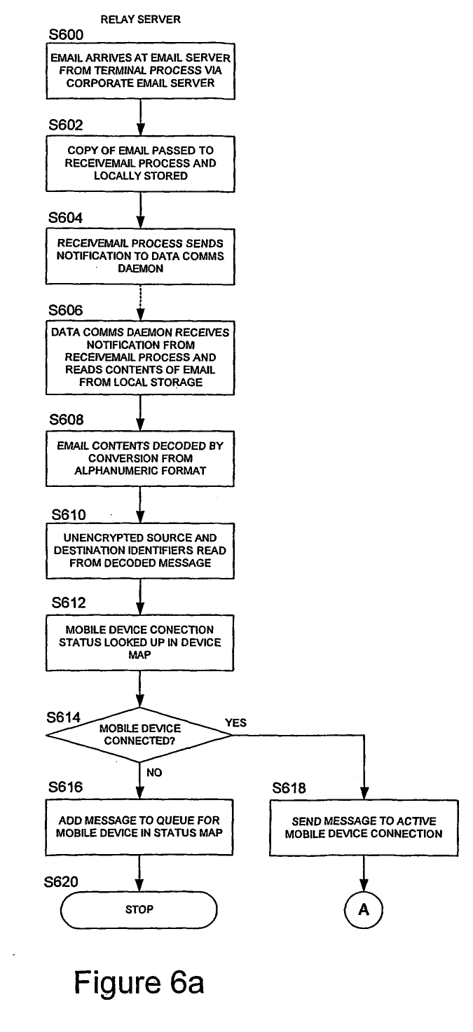

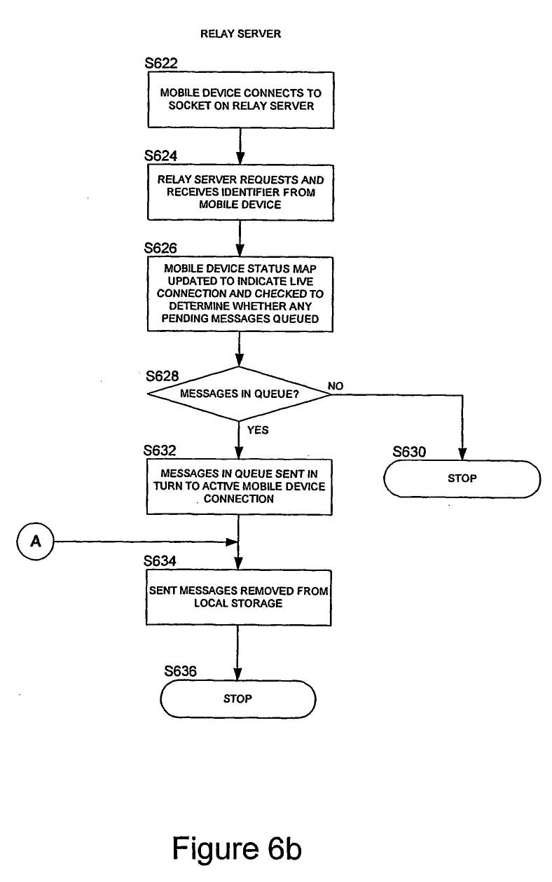

FIGS. 6a and 6b show a flow diagram of a relay server process for establishing a data communication link;

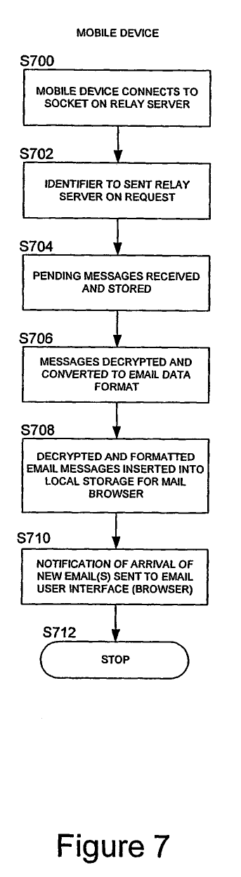

FIG. 7 shows a flow diagram of a mobile device process for receiving data;

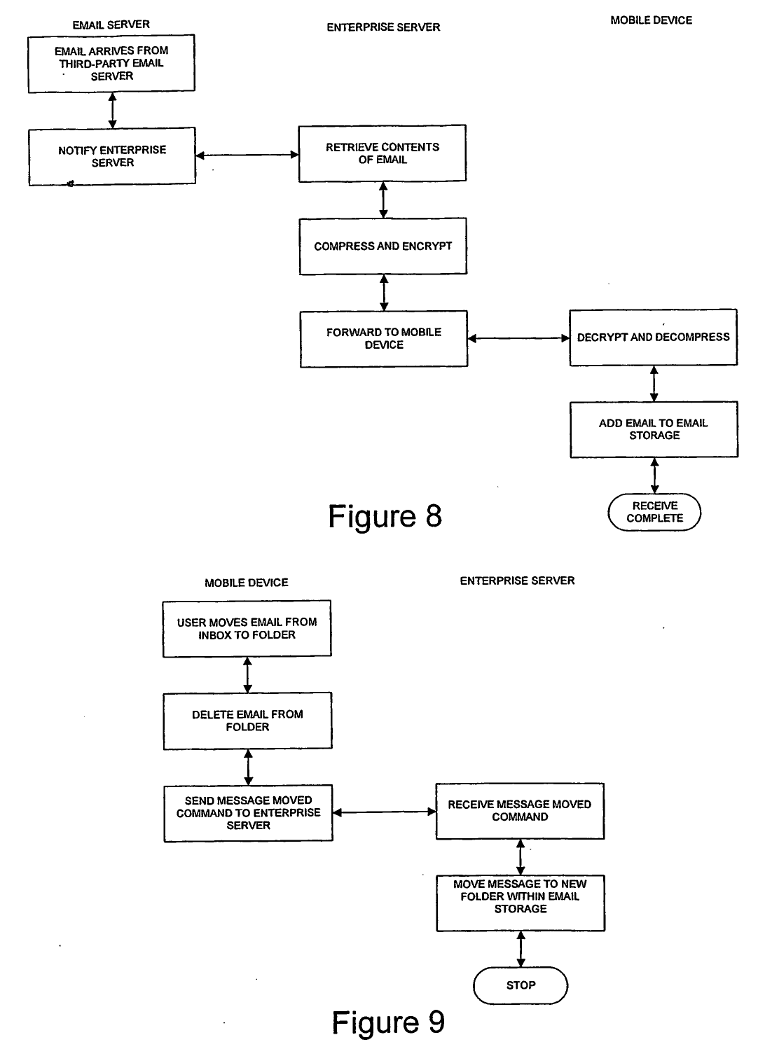

FIG. 8 shows a flow diagram of steps in procedures at an email server, intermediate server, and mobile device when an email is received; and,

FIG. 9 shows steps of procedures of a mobile device and intermediate server when an email is moved from one folder to another on the mobile device.

Broadly speaking the “File and Forget” system described herein allows users to balance the competing requirements of mobile email by providing mobile terminals such as PDAs (Personal Digital Assistants) with the ability to file messages within folders, without storing the contents of these folders on the device. The structure of the folder hierarchy is duplicated on the portable device, but the contents are not. Messages can be filed within a folder and any such operation is mirrored on the user's desktop, but at this point they disappear from the device.

Many users who make heavy use of folders follow a reasonably standard sequence of actions for each message that they receive. When the message arrives, they read it to determine whether it needs immediate attention. If it does need immediate attention, they reply at that time. The message is then either deleted or filed within a folder for later attention. At some point in the future, they may revisit the filed message, but this initial sequence is typically performed over a very short period of time for each message.

The “File and Forget” mechanism allows a user to complete this initial sequence for each message, without having the overhead of storing the contents of their entire folder hierarchy on their device.

An enhancement of the technique allows folders to be marked as either “File or Forget” or “Mirror” on a case-by-case basis. This allows the user to store some important messages on their device while avoiding the overhead of storing less important messages.

This technique is applicable to a desktop redirector, as described above, or to a server-based “enterprise” redirector as described later. In the enterprise case, a single server performs the job of multiple desktop redirectors for multiple users, allowing them to switch their desktop computers off (or even remove them from the network as in the case of a laptop user).

In the e-mail system described below a user's mail resides on a corporate e-mail server. While the user is in the office, they access their e-mail from their PC. While they are out of the office, they access their e-mail from their PDA. Messages are forwarded from the Duality Enterprise Server to the PDA via the Duality Relay Server. Control messages (e.g. “mark message 465 as read”, “delete message 984”) are sent from the PDA to the Enterprise Server via the Relay Server. Upon receipt of such a control message, the Enterprise Server performs the relevant operation on the corporate e-mail server.

Implementing File and Forget involves, in embodiments, the following processes:
Replicating the folder structure on the PDA
Detecting folder move operations performed by the user on the PDA
Deleting the message from the PDA
Sending a new control message from the PDA to the Enterprise Server
Replicating the relevant move operation on the corporate e-mail server.

Referring now to FIG. 2a this shows a mobile email system 200 in which the present invention may be embodied. More particularly FIG. 2a shows information flow when an e-mail is sent from a third party terminal 202 via a third party e-mail server 204, a corporate e-mail server 210 of a corporate network 208, and the Internet 206 to a mobile terminal or device 228.

Corporate computer network 208 comprises, as well as corporate e-mail server 210, a plurality of desktop terminals 214a, b, c, typically desktops PCs, and proxy server and firewall 216; these components are all connected together by LAN 212. A corporate network will typically comprise other components but, for simplicity, these are not shown. A relay server 218 is connected to the Internet 206 and also to a wireless gateway 220 to a wireless network 222. In some arrangements the relay server may be connected within the mobile network service provider's network rather than directly connected to the Internet. Wireless network 222 may comprise, for example a digital mobile phone network providing data communications. The wireless network 222 has a plurality of base stations such as base stations 224 to enable communication with a plurality of mobile stations, for example mobile phones such as mobile station 226. In this way mobile station 226 is provided with data communication facilities coupling the mobile station to the Internet or, in this embodiment, to relay server 218. When the mobile station 226 is attached to the wireless network 222 and enabled for data communications it is provided with an IP address, and to the outside world, simply appears as a device with which TCP/IP communications may be conducted. In the specific embodiment illustrated in FIG. 2a mobile station 226, for example a GPRS mobile phone, has a radio (Bluetooth) link to an associated mobile terminal 228, for example a Bluetooth-enabled palm top or PDA.

Consider a user of one of desktop terminals 214. The user's e-mail resides on corporate e-mail server 210 within the firewall 216 and the user normally retrieves their e-mail from a terminal (PC) such as terminal 214a also located within the firewall. Arrow 1 230 shows the flow of information when e-mail from terminal 202 is sent by third party e-mail server 204, located outside the firewall, to the user.

The e-mail reaches the corporate mail server 210 through the firewall which has been configured to allow incoming e-mail. Software running on the user's terminal 214a retrieves the e-mail from the corporate mail server (Arrow 2 232) and then a process running on terminal 214a creates what may be termed a “protocol e-mail” containing an encoded representation of the original message. This process then instructs the corporate e-mail server 210 (Arrow 3 234) to send the protocol e-mail to relay server 218 located outside the firewall. This protocol e-mail reaches the relay server 218 through the firewall (Arrow 4 236) because the firewall has been configured to permit outgoing e-mail. The relay server 218 receives the protocol e-mail, extracts the information contained within it, and creates a conventional TCP connection to software running on the user's mobile terminal or PDA 228. The contents of the original e-mail from the third party are then forwarded over this connection (Arrow 5 238).

Communication is also possible in the reverse direction, as illustrated in FIG. 2b. In FIG. 2b like elements to those of FIG. 2a are indicated by like reference numerals.

In FIG. 2b the user creates and sends an e-mail using conventional e-mail user software running on mobile terminal or PDA 228. A software process running on mobile terminal 228 detects this action and sends the details of the new e-mail to the relay server 218 over a conventional TCP connection (Arrow 1 240). The relay server 218 then creates a protocol e-mail containing a coded representation of the user's e-mail and sends this over Internet 206 and through firewall 216 to the corporate e-mail server 210 (Arrow 2 242), where it is passed to desktop terminal 214a (Arrow 3 244). Here the information contained within the protocol e-mail is extracted and the e-mail, which comprises the contents of the e-mail on a software process running on desktop 214a then creates a new conventional e-mail containing the information extracted from the protocol e-mail and instructs (Arrow 4 246) the corporate e-mail server 210 to send it. This new e-mail is then sent to its destination (Arrow 5 248), for example terminal 202 via third party e-mail server 204, in the normal way. This new e-mail comprises the contents of the user's original e-mail sent from mobile device 228 and has a destination as specified by the user when the e-mail was created using the mobile terminal. A message sent out this way may be substantially indistinguishable from one sent manually by the user from a desktop terminal 214. Transmission to a mobile terminal may sometimes be delayed, for example when the mobile terminal is not connected to the wireless network.

Although in both the foregoing examples the “protocol e-mail” is created on desktop terminal 214a and, conversely, information is extracted from the protocol e-mail by a process running on terminal 214a, the skilled person will appreciate that these software processes could equally reside on corporate e-mail server 210.

Still referring to FIG. 2b, in another example the user reads and deletes an e-mail using conventional e-mail browser software running on mobile terminal 228. In this case, again software on mobile terminal 228 detects this action and sends data representing this action via wireless network 222 to relay server 218 (Arrow 1 240). The relay server 218 then, as before, creates a protocol e-mail, but in this example the protocol e-mail contains a coded representation of the delete notification. The relay server 218 then sends (Arrow 2 242) this e-mail to the user's e-mail address. The protocol e-mail reaches the corporate e-mail server 210 through the firewall 216 which has been configured to permit incoming e-mail.

A software process on the user's terminal 214a is notified of the arrival of the protocol e-mail by the corporate e-mail server 210, and this software process retrieves (Arrow 3 244) the protocol e-mail, decodes the protocol e-mail (to extract the delete notification), and then deletes the protocol e-mail. As protocol e-mails are deleted as soon as they arrive they are not visible to the user. Since the e-mail is recognised as a protocol e-mail it is not forwarded back to the mobile terminal 228 as a third party e-mail would be. The software process then instructs (Arrow 4 246) the corporate e-mail server to delete the e-mail according to the delete notification received from mobile terminal 228, thus automatically synchronising the mobile terminal 228 to the corporate e-mail server 210. It will be appreciated that other e-mail manipulation instructions may be sent from terminal 228 to e-mail server 210 or from desktop terminal 214 via server 210 to mobile terminal 228 in a corresponding manner.

Thus a representation of e-mails on corporate e-mail server 210 may be held on mobile terminal 228, these e-mails preferably mirroring those on e-mail server 210, and the two sets of e-mails may be automatically synchronised. The user may thus be provided with a single e-mail address even though e-mails are being received, read, deleted and otherwise manipulated at mobile terminal 228 and desktop 214, actions on either terminal affecting the e-mails accessed by both terminals. To the user the effect is of making the fixed desktop terminal mobile since a single e-mail address is maintained and e-mail manipulations and responses formed using either terminal are automatically updated so that the user has substantially the same logical (rather than physical representational) view of their e-mails from either terminal. Although this will not be the case immediately after the mobile terminal 228 has been switched on after a long period of disconnection, the system can be configured to automatically synchronise upon or soon after switch on and data communications attachment to a relevant wireless network.

The above-described techniques do not depend upon the use of any particular e-mail protocol, such as SMTP, for communications with the corporate e-mail server 210 either with third parties across firewall 216. However in a typical installation, as will be described in more detail below, the desktop terminal comprises a PC which communicates with corporate e-mail server 210 by means of Microsoft's Messaging API (MAPI) and the server 210 sends and receives e-mail using MSTP. This is not essential, however, and it is merely necessary that the firewall 216 is configured to permit single or preferably bi-directional communication using which ever protocol the e-mail server uses.

Broadly speaking the function of relay server 218 is to provide a machine which is substantially always on (or connected to Internet 206) and which can therefore act as a substantially permanent entity for receiving and/or sending e-mails. This is advantageous since a wireless-connected mobile station may be switched off or in an area of poor or non-existent wireless network coverage. However, for example, two communicating computer systems both have a permanent Internet connection the relay server may be dispensed with.

FIG. 2c shows an example of a system which corporate e-mail server 210 is in communication with a second corporate computer network 250 including a second corporate e-mail server 252. Like network 208, corporate network 250 includes a proxy server and firewall 254 behind which corporate e-mail server 252 is located. Again, like network 208, network 250 has a plurality of desktop 256a-c and elements of the network are interconnected by a LAN 258. Broadly speaking corporate e-mail server 252 performs the functions of relay server 218 and one or more of the desktop terminal 216 perform the functions of mobile terminal 228. Thus, broadly speaking, the system of FIG. 2c operates similarly to that of FIG. 2a and respective arrows 260, 262, 264, 266 and 268 of FIG. 2c corresponds to arrows 230, 232, 234, 236, 238 of FIG. 2a.

Broadly speaking these techniques provide a method of communicating data from a first software process on a first machine to a second software process on a second machine, the method comprising: receiving data for communication at said first software process; encoding said received data as an e-mail message using said first software process; sending said e-mail message including said encoded data from said first software process to said second software process through said firewall; receiving said e-mail message including said encoded data at said second software process; decoding said encoded data in said e-mail message using said second software process; and outputting said decoded data from said second software process; and wherein said receiving at said first software process, said encoding and said sending are implemented by said first software process without user intervention; and wherein said receiving at said second software process, said decoding and said outputting are implemented by said second software process without user intervention. A third (mobile terminal) software process may send an identifier to said second software process; receive data from said second software process, said received data comprising data defining an e-mail header and at least partial e-mail message data; reconstruct an e-mail comprising said at least partial e-mail message from said received data; and notify an e-mail user interface of the availability of said reconstructed e-mail.

FIG. 2d illustrates what happens in another mobile email system when an e-mail arrives:
1. An e-mail arrives at the corporate e-mail server.
2. The corporate e-mail server notifies the Enterprise Sever that a new message has arrived.
3. The Enterprise Server retrieves the contents of the message from the e-mail server, compresses and encrypts them and then sends the message to the Relay Server.
4. The Relay Server forwards the compressed, encrypted message to the mobile device where it is decrypted and decompressed and entered into the e-mail database on the mobile device.

FIG. 2e illustrates what happens when the user files an e-mail on the mobile device:
1. Code running on the mobile terminal detects that the user has filed an e-mail, deletes it from the folder that it has been moved to and sends a “move message” command to the Relay Server.
2. The Relay Server forwards the command to the Enterprise Server.
3. The Enterprise Server receives the command and performs the relevant move operation on the corporate e-mail server.
4. The e-mail server notifies the relevant user's desktop and the operation is mirrored there.

Referring now to FIG. 3a, this shows a block diagram illustrating a system such as that shown in FIG. 2a in greater detail. Again, like elements to those of FIG. 2a are indicated by like reference numerals. FIG. 3b shows examples of e-mail storage folder structures for the e-mail server and mobile device.

User terminal 214 has an operating system comprising operating system code 300 and including network communications code 302, in this embodiment for TCP/IP communications. Applications software installed on terminal 214 includes Microsoft Outlook (trade mark) or some other Messaging API 304. Also installed on terminal 214 is e-mail pre-processing and e-mail-based data communications code 306, preferably for bi-directional communication using what have been termed above as “protocol e-mails”. Terminal 214 also stores an (IP) address for relay server 218. In operation the data communications code 306 registers with the MAPI code 304 for notification of arrival of e-mails, to send e-mails, and for other e-mail manipulation functions.

It will be understood that the data communications code 306 (and the relay server address) could be installed on the e-mail server 210 or on some other machine or server. Installation of the code on either an existing or a dedicated server is preferred in some environments as, for example, a single such server may then serve a plurality of desk top terminals which may or may not themselves have a portion of the data communications code installed on them. The data communications code 306, or other code in terminal 214, may be provided on a removable storage medium, such as disk 307.

The e-mail server 210 is connected to terminal 214 by LAN 212. In a conventional manner, e-mail server 210 includes TCP/IP code 308, an e-mail server 310 such as Microsoft Exchange (trade mark) and local e-mail storage 312. The skilled person will understand that although e-mail code 310 is termed a server, in fact it behaves as a client when sending to another server. As previously described, e-mail server 210 is connected to Internet 206 via firewall 216.

The relay server 218, in the illustrated embodiment, has a Unix or Unix variant operating system 314 (although other operating systems such as Windows (Trade Mark) could also be employed) and TCP/IP communications code 316. Also installed on relay server 218 is conventional e-mail transport code 318, for example based upon sendmail, as well as e-mail storage code 320 (here termed “receivemail”) and a Unix Daemon 322 providing protocol e-mail-based and TCP-based data communications. The receivemail code 320 communicates between e-mail transport code 318 and the data communications code 322. Relay server 218 also provides local e-mail storage 324, typically as files on a hard disk, and a mobile device status map data structure 326.

Data structure 326 comprises a set of mobile device (or PDA) identifiers. Each mobile device identifier is associated with a list of pending e-mails for that mobile device (which may be a blank list) and with a flag indicating whether or not a connection to the identified mobile device is active. Part or all of the relay server code, such as receivemail code 320 and/or data communications code 322 and/or data structure 326 may be provided on a persistent optionally removable storage medium, as illustrated by disk 328.

Relay server 218 is coupled, via Internet 206, wireless gateway 220 and wireless network 222 to mobile device 228. Mobile device 228 includes a mobile device operating system 330 and a conventional e-mail browser/client 332. For example, the Pocket PC 2002 (Trade Mark) operating system includes an e-mail client called Pocket (Outlook) Inbox with configurable connections for POP and IMAP servers. In the present arrangement, however, mobile device 228 includes e-mail transport code 334, implemented as a protocol driver for Pocket Inbox and configured for communicating with data communications code 322 on relay server 218. Transport code 334 is configured to interface with a Microsoft software interface into their e-mail application for attaching a new transport layer. However the system is not dependent upon any particular PDA or hardware platform and in other embodiments different operating systems, such as PalmOS (Trade Mark) may be employed. Once e-mail transport protocol driver code 334 is installed for use with Pocket Inbox it appears as an additional option with POP and IMAP and, as far as a user is concerned, it may be selected similarly to the other options. In this way e-mails may be sent from relay server 218 to the e-mail browser 332 of mobile device 228. E-mail browser 332 provides conventional e-mail manipulation functions such as e-mail retrieve and display, e-mail send, e-mail delete and, normally, means for modifying settings such as flag settings, priority settings and the like.

Some or all of the code for mobile device 228, and in particular e-mail transport 334, may be provided on a removable storage medium, illustrated by disk 336. In practice PDA software is usually distributed on a CD and installed while the PDA is in a docking cradle attached to a PC. A single install, either from a CD or from the Internet, may install software both on the desktop PC and on an attached PDA (in docking cradle at the time).

Referring now to FIG. 4, this shows a general purpose computer system 400 suitable for use as user terminal 214, e-mail server 210, relay server 218 or, in portable form, mobile device 228. As illustrated the computer system is configured for use as a user terminal such as terminal 214. The computer has a data and address bus 402 connecting a network interface 404, a pointing device 406, such as a mouse, a keyboard 408 and a display 410. Also coupled to bus 402 is working memory 414, such as RAM, here shown storing e-mail data, and permanent program memory 416, for example comprising non-volatile storage such as EPROM, Flash, Flash RAM or a hard disk. Program memory 416 stores the operating system code 300, the network communications code 302, the MAPI code 304 and the data communications management code 306 and, when not included in MAPI code 304, an e-mail browser. Part or all of this code may be provided on a carrier medium such as a disk 418. A processor 412 is also coupled to bus 402 to implement the operating system, network communications, e-mail pre-processing and data communications, messaging API and e-mail management.

Referring now to FIG. 5, this shows a flow chart of software processes operating on corporate e-mail server 210 and a desk top terminal 214 for handling an incoming third party e-mail such as is shown, for example, in FIG. 2a.

At step S500 the incoming e-mail arrives at the corporate e-mail server and, at step S502, the messaging API into MS Exchange sends a notification of e-mail arrival to desk top terminal process 306. In other embodiments, the desk top process may instead be running on the corporate e-mail server or on another server machine.

The desk top terminal data communications process 306 reads a copy of the e-mail from the corporate e-mail server 210, at step S504. The terminal data communications process then, at step S506, compiles or packages the e-mail into a message containing, preferably, both the e-mail message body and the e-mail header including date, subject, priority, source and destination address information. To this message is then added, at step S508, a source and destination identifier.

In one embodiment, the source identifier is the e-mail address of the desk top terminal, for example user@corporation.com and the destination identifier comprises an identifier of the user's mobile device. In one embodiment this is simply a modified version of the user's e-mail address, with the “@” symbol replaced by double quotes, for example user “corporation.com. Thus the identifier of the mobile device is not a valid e-mail address, to avoid confusion, but can be generated from the user's address (or vice versa). It will be appreciated that with this arrangement there is no need to send both a source and destination identifier since one can be generated from the other.

At step S510 the compiled message, but preferably not the source and destination identifiers, is encrypted. In many applications, the mobile device or PDA will be periodically docked with the desk top terminal, that is directly connected using a serial cable or wireless link. This allows the mobile device and desk top terminal to securely share a key, making computationally expensive asymmetric public key cryptographic algorithms unnecessary. Instead symmetric algorithms relying on a shared secret key, such as the NIST Advanced Encryption Standard Algorithm mentioned above may be employed. Such algorithms nonetheless provide a high degree of security, the advanced encryption standard for example having a 128 bit key length.

At step S512 the encrypted message is encoded by converting it to an alphanumeric representation, for example by mapping groups of bits onto ASCII or other characters. Then, at step S514, the terminal data communications process 306 contacts the exchange server 310, via MAPI 304, to request that the encrypted, encoded message is sent as an e-mail to relay server 218. The destination address of the e-mail is therefore given as the address of the relay server (which is known to the terminal process) and, preferably, the source address is given as the address of the desk top terminal. The exchange server process 310 then, at step S516, sends the e-mail to relay server 218 and, at step S518, the sender end procedure then stops.

It will be appreciated that neither the outgoing “protocol e-mail” nor the unencrypted (but encoded) source and destination identifiers disclose the true source address and destination address of the original, third party incoming e-mail. This is because, as can be appreciated from the foregoing discussion, the source and destination of the original e-mail are part of the encrypted data which, as will be seen below, remains encrypted as it passes through the relay server and is only decrypted once it has finally arrived at the mobile device.

Referring next to FIG. 6, this shows a flow diagram of software processes operating on the relay server 218.

Initially, at step S600, the “protocol e-mail” arrives at the relay server e-mail transport server 318 from the data communications process 306, via e-mail exchange server 310 and the Internet 206. On arrival a copy of this incoming protocol e-mail is passed to e-mail storage process 320 (here called “receivemail”) which locally stores the incoming e-mail in e-mail storage 324 (step S602). The receivemail process 320 then sends a notification to the data communications process 322, at step S604. The data communications process 322 then takes over at step S606.

At step S606 data communications process 322 receives notification from the receivemail process 320 and reads the contents of the incoming protocol e-mail from local storage 324. The contents of this e-mail, that is the e-mail message, is then decoded at step S608, converting the message back from an alphanumerical format into binary data. This binary data includes unencrypted source and destination identifiers, as described above, which at step S610 are read from the decoded message. The remainder of the message, however, is left encrypted.

The destination identifier identifies the mobile device associated with the desk top terminal from which the protocol e-mail was sent. Thus, at step S612, the connection status of the identified destination mobile device is looked up in mobile device status map 326, in particular to determine whether or not there is an existing (active) connection to the destination mobile device (step S614). If there is no active connection to the mobile device, at step S616, the message is added to the queue for the mobile device in status map 326. Since the e-mail has already been stored, adding the message to the queue can be achieved by adding a pointer to the message to a list of pending e-mails associated with the destination mobile device identifier. The process then stops at step S620. If, on the other hand, the destination mobile device does have an active connection to the data communications process 322, at step S618 the decoded binary message is sent to the destination mobile device using the active (TCP/IP) connection. The sent message is then removed (deleted) from local storage 324 (step S634) and the procedure halts at step S636. Preferably at step S614 the procedure checks not only whether the mobile device is connected but also whether or not the queue is empty. This second condition prevents new messages arriving just as the queue is being emptied from overtaking old ones, which is undesirable.

The procedure by which a mobile device attaches to the data communications process 322 to provide an active connection is shown in steps S622 to S632. At step S622 a mobile device connects to a socket on relay server data communications process 322 which is listening for an incoming connection request. Then, at step S624, the data communications process 322 requests, and receives, an identifier from the just-connected mobile device. Once the identifier has been received mobile device status map 326 is updated to indicate that an active connection to the identified mobile device is available and a check is made to determine whether there are any pending messages for the just-connected mobile device (step S626). If, at step S628, there are no messages in the queue for the mobile device, the procedure halts at step S630. If there are messages to be sent then, at step S632, these messages are sent sequentially to the mobile device, preferably oldest first. The procedure then continues, as before, at step S634, the sent messages being deleted from the local e-mail storage 324. The primary function of local e-mail storage 324 is to provide a queue should a mobile device be out of contact. Generally speaking it is not necessary to queue messages arriving from a mobile device since the e-mail server for the destination desk top terminal will generally be “always on”, that is always connected. However, an additional benefit of e-mail storage 324 is that it provides a backup facility in case, for example, of power failure.

The procedure for the mobile terminal to receive the messages is shown in FIG. 7.

At step S700, the mobile device connects to a socket on relay server communications process 322 and at step S702, in embodiments in response to a request from the relay server, sends the server its mobile device identifier. The mobile device then, at step S704, receives any pending messages from the relay server and stores these locally. The received message or messages are then decrypted, at step S706, using the secret key known to both the mobile device and the associated desk top terminal, and converted back to an e-mail data format. The decrypted and suitably formatted e-mail message or messages are then, at step S708, inserted into local storage for mobile device mail browser 332. At step S710, notification of the arrival of new e-mail is then sent to the e-mail browser (possibly indirectly via an intermediate software process) which can then alert the user to new incoming mail. The process then halts at step S712.

The e-mail browser 332 provides a user interface which allows a user to read, manipulate, create and reply to e-mails in a conventional manner. Preferably the connection to the relay server is left open to facilitate reception of further e-mails as they arrive. Data representing such e-mail manipulations and/or data representing outgoing e-mails from the mobile device may be sent to the relay server over the open TCP/IP connection. This data may then sent through the firewall 216 back to the user's desk top terminal using the same “protocol e-mail” tunnelling techniques as described above. Broadly speaking, the above described process is simply reversed to send data in the opposite direction and, for conciseness, the description will not be repeated. However, the skilled person will appreciate that, as mentioned above, for communications originating from the mobile device the relay server does not need to maintain a queue since the e-mail server supporting the desk top terminal to which the data is directed will in general be substantially always connected.

FIG. 8 shows a flow diagram of steps in procedures at an email server, intermediate server, and mobile device when an email is received; and, FIG. 9 shows steps of procedures of a mobile device and intermediate server when an email is moved from one folder to another on the mobile device.

No doubt many other effective alternatives will occur to the skilled person and it will be understood that the invention is not limited to the described embodiments and encompasses modifications apparent to those skilled in the art lying within the spirit and scope of the claims appended hereto.

1. A method of managing emails in a mobile terminal of a mobile e-mail system, the mobile email system comprising an email server coupled to a static terminal and in wireless communication with said mobile terminal, said static terminal having a folder-based data storage structure for storing emails received by a user of said static terminal, said email server also being configured to provide said received emails to said mobile terminal, said mobile terminal locally duplicating at least a portion of said static terminal folder-based data storage structure, whereby said user is able to manage emails sent to a single address using said static and said mobile terminal, the method comprising:
inputting, at said mobile terminal, a command from said user to move an email from a first folder of said local storage structure to a second folder of said local storage structure;
deleting said email from said local storage of said mobile terminal responsive to said user move command; and
sending said move command from said mobile terminal to said email server.

2. The method as claimed in claim 1 wherein said first folder comprises an incoming mail-box of said mobile terminal.

3. The method as claimed in claim 1 wherein said second folder of said storage structure local to said mobile terminal has associated property data for specifying said second folder as a folder in which emails are not to be stored locally in said mobile terminal, and wherein said deleting is conditional upon said property data.

4. The method as claimed in claim 1, wherein said sending of said move command comprises encoding said move command as a command email and sending said command email.

5. The method as claimed in claim 1 wherein said mobile terminal is in intermittent contact with said email server, said method further comprising connecting said mobile terminal to said server via an internet connection.

6. A mobile terminal for a mobile email system, the mobile email system comprising an email server coupled to a static terminal and in wireless communication with said mobile terminal, said static terminal having a folder-based data storage structure for storing emails received by a user of said static terminal, said email server also being configured to provide said received emails to said mobile terminal, said mobile terminal comprising:
program memory storing processor implementable instructions;
data memory locally duplicating at least a portion of said static terminal folder-based data storage structure; and
a processor coupled to said program memory and to said data memory, for loading and implementing said instructions, said instructions comprising instructions for controlling the processor to:
input, at said mobile terminal, a command from said user to move an email from a first folder of said local storage structure to a second folder of said local storage structure;
delete said email from said local storage of said mobile terminal responsive to said user move command; and
send said command from said mobile terminal to said email server.

7. The mobile terminal claimed by claim 6, wherein the processor implementable instructions are carried by a data carrier.

8. A method of managing emails in a mobile email system, comprising:
implementing the method of claim 1;
receiving said move command at said email server; and
sending a command to perform said move to said static terminal.

9. The method as claimed in claim 8 wherein said email server comprises a first email server for receiving and sending emails to and from said user from and to a third party, and a second email server for sending emails to said mobile terminal and receiving and forwarding commands from said mobile terminal; the method further comprising receiving said move command at said second email server and forwarding said move command to said first email server; and wherein said first email server performs said command sending to said static terminal.

10. An email management system configured to operate in accordance with claim 9.

11. A method of managing documents in a mobile terminal of a mobile document system, the mobile document system comprising a document server coupled to a static terminal and in wireless communication with said mobile terminal, said static terminal having a folder-based data storage structure for storing documents received by a user of said static terminal, said document server also being configured to provide said received documents to said mobile terminal, said mobile terminal locally duplicating at least a portion of said static terminal folder-based data storage structure whereby said user is able to manage documents sent to a single address using said static and said mobile terminal, the method comprising:
inputting, at said mobile terminal, a command from said user to move a document from a first folder of said local storage structure to a second folder of said local storage structure;
deleting said document from said local storage of said mobile terminal responsive to said user move command; and
sending said move command from said mobile terminal to said document server.

12. (canceled)

13. A method of managing documents in a mobile document system, comprising:
implementing the method of claim 11;
receiving said move command at said document server; and
sending a command to perform said move to said static terminal.

14. A mobile terminal for a mobile document system, the mobile document system comprising a document server coupled to a static terminal and in wireless communication with said mobile terminal, said static terminal having a folder-based data storage structure for storing documents received by a user of said static terminal, said document server also being configured to provide said received documents to said mobile terminal, said mobile terminal comprising:
program memory storing processor implementable instructions;
data memory locally duplicating at least a portion of said static terminal folder-based data storage structure; and
a processor coupled to said program memory and to said data memory, for loading and implementing said instructions, said instructions comprising instructions for controlling the processor to:
input, at said mobile terminal, a command from said user to move a document from a first folder of said local storage structure to a second folder of said local storage structure;
delete said document from said local storage of said mobile terminal responsive to said user move command; and
send said command from said mobile terminal to said document server.

15. A document management system configured to operate in accordance with a method of managing documents in a mobile document system, comprising:
implementing the method of claim 11;
receiving said move command at said document server; and
sending a command to perform said move to said static terminal, wherein said document server comprises a first document server for receiving and sending documents to and from said user from and to a third party, and a second document server for sending documents to said mobile terminal and receiving and forwarding commands from said mobile terminal; the method further comprising receiving said move command at said second document server and forwarding said move command to said first document server; and wherein said first document server performs said command sending to said static terminal.
